(19) United States
(12) Patent Application Publication
(10) Pub. No.: US 2022/0155121 A1
(43) Pub. Date: May 19, 2022

(54) AIRFLOW METER

(71) Applicant: DENSO CORPORATION, Kariya-city (JP)

(72) Inventors: Hajime MASHITA, Kariya-city (JP); Hiroyuki AKUZAWA, Kariya-city (JP)

(21) Appl. No.: 17/591,323

(22) Filed: Feb. 2, 2022

Related U.S. Application Data
(63) Continuation of application No. PCT/JP2020/033288, filed on Sep. 2, 2020.

(30) Foreign Application Priority Data
Sep. 4, 2019 (JP) 2019-161246

(51) Int. Cl. G01F 1/69; G01F 15/14; F02M 35/10

(52) U.S. Cl. CPC G01F 1/69; F02M 35/10386; G01F 15/14

(57) ABSTRACT

An airflow meter includes a housing including a base surface, a rear surface, a first side surface, a second side surface, a flow-rate inlet portion, a flow-rate outlet portion, a passage, and a physical quantity inlet portion, a flow rate detector, a board, and a physical quantity detector mounted on a board surface. The physical quantity inlet portion includes a first inner surface, a second inner surface, a third inner surface, and a fourth inner surface. The physical quantity detector is configured to output signals according to a physical quantity of air flowing through a board passage. The board, the first inner surface, the third inner surface, and the fourth inner surface are arranged to reduce a cross-sectional area of the board passage from the base surface toward the rear surface.

### CROSS REFERENCE TO RELATED APPLICATION

The present application is a continuation application of International Patent Application No. PCT/JP2020/033288 filed on Sep. 2, 2020, which designated the U.S. and claims the benefit of priority from Japanese Patent Application No. 2019-161246 filed on Sep. 4, 2019. The entire disclosures of all of the above applications are incorporated herein by reference.

### TECHNICAL FIELD

The present disclosure relates to an airflow meter.

### BACKGROUND

A sensor device includes a flow rate sensor configured to measure a flow rate of air and a temperature sensor configured to measure the temperature of air. The flow rate sensor and the temperature sensor of this sensor device are mounted on a printed circuit board.

### SUMMARY

An airflow meter includes a housing, a flow rate detector, a board, and a physical quantity detector. The housing includes a base surface on which a flow-rate inlet passage portion and a physical quantity passage inlet portion are open, a rear surface on which a flow-rate passage outlet portion is open, the rear surface being located opposite to the base surface, a first side surface connecting between an end of the base surface and an end of the rear surface, a second side surface connecting between an opposite end of the base surface and an opposite end of the rear surface, and a flow-rate passage fluidly connecting between the flow-rate passage inlet portion and the flow-rate passage outlet portion. The flow rate detector is disposed in the flow-rate passage and configured to output signals according to a flow rate of an air flowing through the flow-rate passage. The board is disposed in the physical quantity passage inlet portion and has a board surface facing in a direction toward the first side surface. The physical quantity detector is mounted on the board surface of the board. The physical quantity passage inlet portion includes a first inner surface, a second inner surface, a third inner surface, and a fourth inner surface. The first inner surface forms a side of the physical quantity passage inlet portion located close to the first side surface, the second inner surface forms a side of the physical quantity passage inlet portion close to the second side surface, the third inner surface connects between the base surface, an end of the first inner surface, and an end of the second inner surface, and the fourth inner surface connects between the base surface, an opposite end of the first inner surface, and an opposite end of the second inner surface. The physical quantity detector is configured to output signals according to a physical quantity of an air flowing through a board passage defined by the board surface, the first inner surface, the third inner surface, and the fourth inner surface. The board, the first inner surface, the third inner surface, and the fourth inner surface are arranged such that a cross-sectional area of the board passage is reduced in a direction from the base surface toward the rear surface, whereby a cross-sectional area of a portion of the board passage that is defined between the physical quantity detector, the board, the first inner surface, the third inner surface, and the fourth inner surface is less than a cross-sectional area of a portion of the board passage near the base surface.

### BRIEF DESCRIPTION OF DRAWINGS

FIG. 1 is a schematic diagram of an engine system in which an airflow meter of an embodiment is used.

FIG. 2 is a front view of the airflow meter of the first embodiment.

FIG. 3 is a side view of the airflow meter.

FIG. 4 is a side view of the airflow meter.

FIG. 5 is a cross-sectional view taken along a line V-V in FIG. 2.

FIG. 6 is an enlarged cross-sectional view taken along a line VI-VI in FIG. 2.

FIG. 7 is an enlarged view of a portion VII in FIG. 5.

FIG. 8 is a front view of an airflow meter of a second embodiment.

FIG. 9 is an enlarged cross-sectional view taken along a line IX-IX in FIG. 8.

FIG. 10 is an enlarged cross-sectional view taken along a line X-X in FIG. 8.

FIG. 11 is a cross-sectional view of a physical quantity passage of the airflow meter of the second embodiment.

FIG. 12 is a front view of an airflow meter according to another embodiment.

FIG. 13 is an enlarged cross-sectional view taken along a line XIII-XIII in FIG. 12.

FIG. 14 is an enlarged cross-sectional view taken along a line XIV-XIV in FIG. 12.

FIG. 15 is a cross-sectional view of a board protrusion of an airflow meter of another embodiment.

FIG. 16 is a cross-sectional view of a housing protrusion of an airflow meter of another embodiment.

FIG. 17 is a cross-sectional view of a board of an airflow meter according to another embodiment.

FIG. 18 is a cross-sectional view of a board of an airflow meter according to another embodiment.

FIG. 19 is a cross-sectional view of a board of an airflow meter according to another embodiment.

### DESCRIPTION OF EMBODIMENTS

To begin with, examples of relevant techniques will be described.

Conventionally, a sensor device including a flow rate sensor configured to measure a flow rate of air and a temperature sensor configured to measure the temperature of air is known. The flow rate sensor and the temperature sensor of this sensor device are mounted on a printed circuit board.

In the configuration of the sensor device, the temperature sensor is arranged at the tip end of an elongated printed circuit board that is distanced away from a LSI and a microcomputer to suppress the influence of heat generated by the LSI and the microcomputer. Further, the board on which the temperature sensor is mounted is installed in the housing. However, according to the study by the inventors, the size of the printed circuit board is relatively large, so that the heat capacity of the printed circuit board is relatively large. Thus, when the temperature of the air changes, the temperature of the temperature sensor mounted on the printed circuit board is unlikely to change. Therefore, the responsiveness of the temperature sensor deteriorates. It is an objective of the present disclosure to provide an airflow meter that can measure a flow rate of air and improves the responsiveness to a physical quantity of air different from the flow rate.

According to one aspect of the present disclosure, an airflow meter includes a housing, a flow rate detector, a board, and a physical quantity detector. The housing includes a base surface on which a flow-rate inlet passage portion and a physical quantity passage inlet portion are open, a rear surface on which a flow-rate passage outlet portion is open, the rear surface being located opposite to the base surface, a first side surface connecting between an end of the base surface and an end of the rear surface, a second side surface connecting between an opposite end of the base surface and an opposite end of the rear surface, and a flow-rate passage fluidly connecting between the flow-rate passage inlet portion and the flow-rate passage outlet portion. The flow rate detector is disposed in the flow-rate passage and configured to output signals according to a flow rate of an air flowing through the flow-rate passage. The board is disposed in the physical quantity passage inlet portion and has a board surface facing in a direction toward the first side surface. The physical quantity detector is mounted on the board surface of the board. The physical quantity passage inlet portion includes a first inner surface, a second inner surface, a third inner surface, and a fourth inner surface. The first inner surface forms a side of the physical quantity passage inlet portion located close to the first side surface, the second inner surface forms a side of the physical quantity passage inlet portion close to the second side surface, the third inner surface connects between the base surface, an end of the first inner surface, and an end of the second inner surface, and the fourth inner surface connects between the base surface, an opposite end of the first inner surface, and an opposite end of the second inner surface. The physical quantity detector is configured to output signals according to a physical quantity of an air flowing through a board passage defined by the board surface, the first inner surface, the third inner surface, and the fourth inner surface. The board, the first inner surface, the third inner surface, and the fourth inner surface are arranged such that a cross-sectional area of the board passage is reduced in a direction from the base surface toward the rear surface, whereby a cross-sectional area of a portion of the board passage that is defined between the physical quantity detector, the board, the first inner surface, the third inner surface, and the fourth inner surface is less than a cross-sectional area of a portion of the board passage near the base surface.

As a result, the flow rate of air can be measured, and the responsiveness to the physical quantity of air different from the flow rate can be improved.

Embodiments will be described below with reference to the drawings. In the following embodiments, the same or equivalent parts are denoted by the same reference numerals, and their descriptions will be omitted.

### First Embodiment

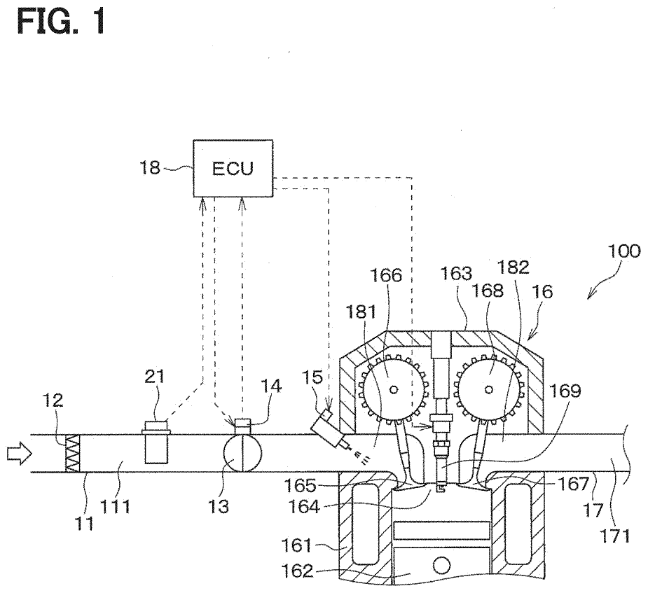

An airflow meter 21 is used, for example, in an intake system of an engine system 100 mounted in a vehicle. First, the engine system 100 will be described. Specifically, as shown in FIG. 1, the engine system 100 includes an intake pipe 11, an air cleaner 12, the airflow meter 21, a throttle valve 13, a throttle sensor 14, an injector 15, an engine 16, an exhaust pipe 17, and an electronic controller 18. Here, the intake air is an air that is sucked. The exhaust air is an air that is discharged.

The intake pipe 11 is formed into a cylindrical shape and defines an intake passage 111. Through the intake passage 111, the air to be taken into the engine 16 flows.

The air cleaner 12 is located in an upstream portion of the intake pipe 11 in a flow direction of air flowing through the intake passage 111 The air cleaner 12 removes foreign matters such as dusts contained in the air flowing through the intake passage 111.

The airflow meter 21 is arranged downstream of the air cleaner 12 in the flow direction of air flowing through the intake passage 111. The airflow meter 21 measures the flow rate of the air flowing through the intake passage 111 between the air cleaner 12 and the throttle valve 13. Further, here, the airflow meter 21 also measures a physical quantity of the air flowing through the intake passage 111. The details of the airflow meter 21 will be described later. Here, the physical quantity of the air flowing through the intake passage 111 is a physical quantity different from the flow rate of the air flowing through the intake passage 111. The physical quantity of air is the temperature of the air as will be described later.

The throttle valve 13 is arranged downstream of the airflow meter 21 in the flow direction of air flowing through the intake passage 111. Further, the throttle valve 13 is formed in a disk shape and is rotated by a motor (not shown). The throttle valve 13 rotates to adjust a passage cross-sectional area of the intake passage 111. Thereby, the flow rate of the air to be taken into the engine 16 can be adjusted.

The throttle sensor 14 outputs detection signals to the electronic controller 18 according to an opening degree of the throttle valve 13.

The injector 15 injects fuel into a combustion chamber 164 of the engine 16 based on the signals from the electronic controller 18 which will be described later.

The engine 16 is an internal combustion engine, and burns a mixed gas, which includes air flowing through the intake passage 111 via the throttle valve 13 and fuel injected through the injector 15, in the combustion chamber 164. Due to an explosive force during combustion, a piston 162 of the engine 16 reciprocates in a cylinder 161. Specifically, the engine 16 includes the cylinder 161, the piston 162, a cylinder head 163, the combustion chamber 164, an intake valve 165, an intake valve driving device 166, an exhaust valve 167, an exhaust valve driving device 168, and a spark plug 169.

The cylinder 161 is formed into a cylindrical shape and houses the piston 162 therein. The piston 162 reciprocates in the cylinder 161 along the axial direction of the cylinder 161. The cylinder head 163 is attached to the upper part of the cylinder 161. Further, the cylinder head 163 is connected to the intake pipe 11 and the exhaust pipe 17, and defines a first cylinder passage 181 and a second cylinder passage 182. The first cylinder passage 181 is in communication with the intake passage 111. The second cylinder passage 182 is in communication with an exhaust passage 171 of the exhaust pipe 17 which will be described later. The combustion chamber 164 is defined by the cylinder 161, the upper surface of the piston 162, and the lower surface of the cylinder head 163. The intake valve 165 is arranged in the first cylinder passage 181 and driven by the intake valve driving device 166 to selectively allow and block a communication between the combustion chamber 164 and the first cylinder passage 181. The exhaust valve 167 is arranged in the second cylinder passage 182 and driven by the exhaust valve driving device 168 to selectively allow and block a communication between the combustion chamber 164 and the second cylinder passage 182.

The spark plug 169 ignites the mixed gas in the combustion chamber 164, which is a mixture of air flowing through the intake passage 111 via the throttle valve 13 and fuel injected through the injector 15, based on signals from the electronic controller 18 which will be described later.

The exhaust pipe 17 is formed into a cylindrical shape and defines the exhaust passage 171. Through the exhaust passage 171, the gas having burned in the combustion chamber 164 flows. The gas flowing through the exhaust passage 171 is purified by an exhaust gas purifying device (not shown).

The electronic controller 18 is mainly composed of a computer or the like, and includes a CPU, a ROM, a RAM, an I/O, a bus line for connecting these configurations, and the like. Here, for example, the electronic controller 18 controls the opening degree of the throttle valve 13 based on the flow rate and physical quantity of the air measured by the airflow meter 21, the opening degree of the throttle valve 13, and the like. Further, the electronic controller 18 controls a fuel injection amount of the injector 15 and an ignition timing of the spark plug 169 based on the air flow rate and physical quantity measured by the airflow meter 21, the opening degree of the throttle valve 13 and the like. In FIG. 1, the electronic controller 18 is illustrated as an ECU.

In this way, the engine system 100 is configured. Next, the details of the airflow meter 21 will be described.

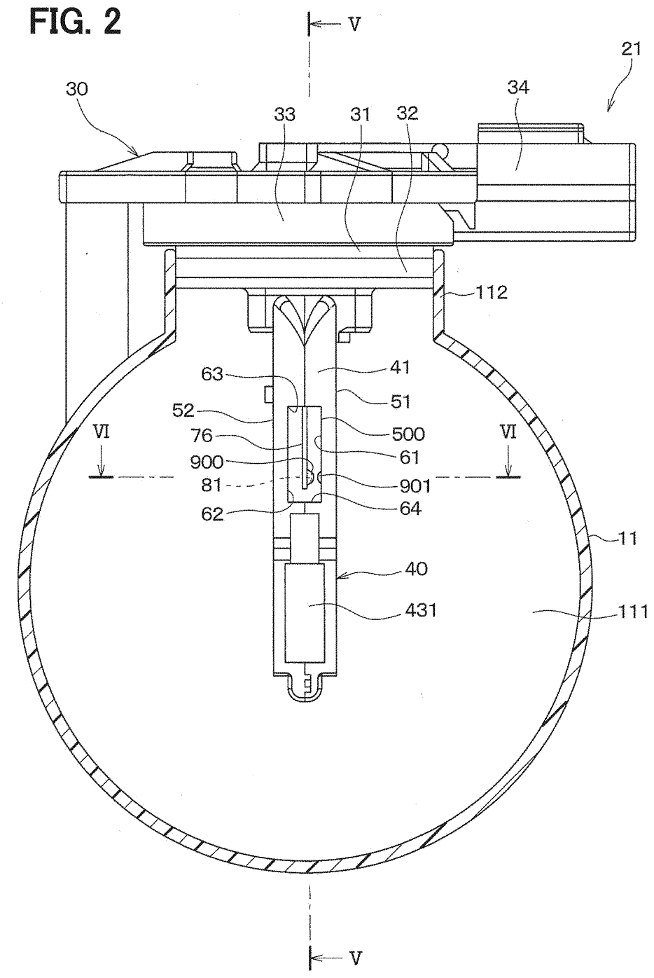

As shown in FIGS. 2 to 7, the airflow meter 21 includes a housing 30, a flow rate detector 75, a board 76, and a physical quantity detector 81.

As shown in FIG. 2, the housing 30 is attached to a pipe extending portion 112 connected to a side surface of the intake pipe 11. The pipe extending portion 112 is formed into a cylindrical shape, and extends radially outward from the side surface of the intake pipe 11. Further, the housing 30 has a holding portion 31, a sealing member 32, a lid portion 33, a connector cover 34, a terminal 35, and a bypass portion 40.

The holding portion 31 is formed into a cylindrical shape, and fixed to the pipe extending portion 112 by an engagement between the outer surface of the holding portion 31 and the inner surface of the pipe extending portion 112. Further, the outer circumferential surface of the holding portion 31 defines a groove to which the sealing member 32 is attached.

The sealing member 32 is, for example, an O-ring and attached to the groove of the holding portion 31 to be in contact with the pipe extending portion 112. Thus, a passage defined in the pipe extending portion 112 is sealed. As a result, it is possible to inhibit the air flowing through the intake passage 111 from leaking to the outside via the pipe extending portion 112.

The lid portion 33 is formed in a bottomed cylindrical shape, and is connected to the holding portion 31 in the axial direction of the holding portion 31. Further, the length of the lid portion 33 in the radial direction of the holding portion 31 is larger than the diameter of the pipe extending portion 112, and the lid portion 33 doses a hole of the pipe extending portion 112.

The connector cover 34 is connected to the lid portion 33 and radially extends from an inner side to an outer side of the holding portion 31 Further, the connector cover 34 is formed in a cylindrical shape and accommodates one end of the terminal 35.

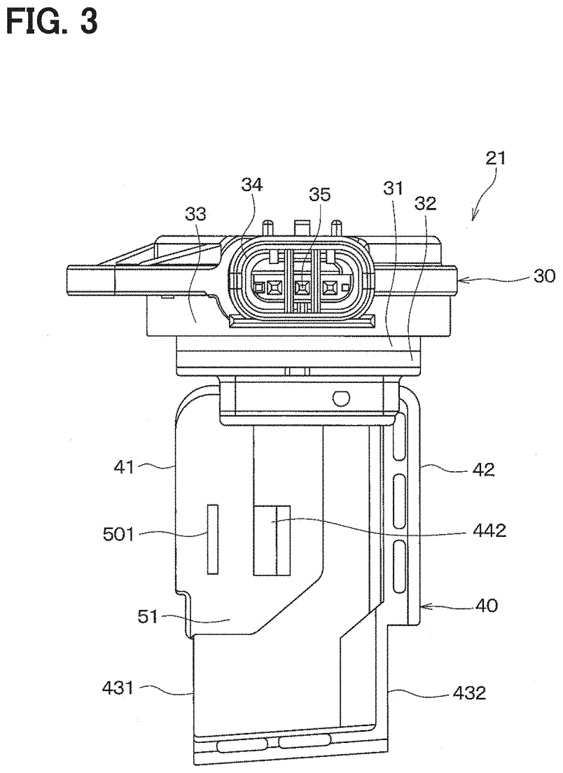

As shown in FIG. 3, one end of the terminal 35 is housed in the connector cover 34. Although not shown, the one end of the terminal 35 is connected to the electronic controller 18. Further, the central portion of the terminal 35 is housed in the lid portion 33 and the holding portion 31. Further, the other end of the terminal 35 is connected to the board 76 which will be described later.

The bypass portion 40 defines multiple passages therein and is formed in a plate shape. Specifically, as shown in FIGS. 2 to 7, the bypass portion 40 has a housing base surface 41, a housing rear surface 42, a first housing side surface 51, and a second housing side surface 52. Further, the bypass portion 40 has a flow-rate main passage inlet portion 431, a flow-rate main passage outlet portion 432, a flow-rate main passage 43, a flow-rate sub-passage inlet portion 441, a flow-rate sub-passage 44, and flow-rate sub-passage outlet portions 442. Further, the bypass portion 40 includes a physical quantity passage inlet portion 500, a physical quantity passage 50, a first physical quantity passage outlet portion 501, and a second physical quantity passage outlet portion 502. In the following, for convenience, a side of the bypass portion 40 near the holding portion 31 of the housing 30 is referred to as an upper side. Further, the side of the bypass portion 40 opposite to the holding portion 31 is referred to as a lower side.

The housing base surface 41 faces an upstream side of the intake passage 111. The housing rear surface 42 is located opposite to the housing base surface 41. The first housing side surface 51 corresponds to a first side surface and is connected to an end of the housing base surface 41 and an end of the housing rear surface 42. The second housing side surface 52 corresponds to a second side surface, and is connected to the opposite end of the housing base surface 41 and the opposite end of the housing rear surface 42. Further, here, the housing base surface 41, the housing rear surface 42, the first housing side surface 51, and the second housing side surface 52 are each formed in a stepped shape.

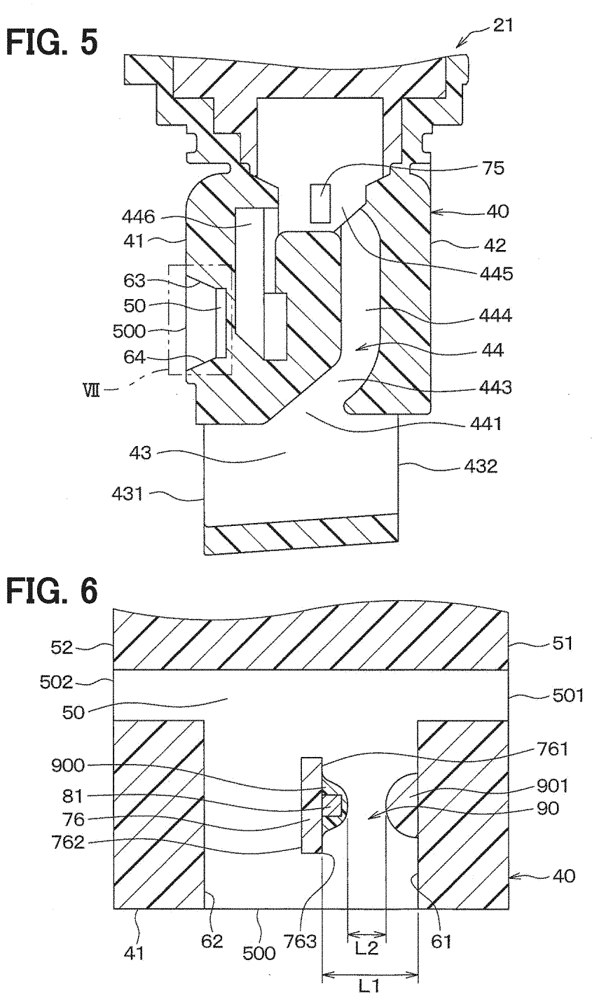

As shown in FIGS. 2 to 5, the flow-rate main passage inlet portion 431 is open on the housing base surface 41, and a part of the air flowing through the intake passage 111 is introduced into the flow-rate main passage 43 through the flow-rate main passage inlet portion 431. As shown in FIG. 5, the flow-rate main passage 43 is in communication with the flow-rate main passage inlet portion 431 and the flow-rate main passage outlet portion 432. As shown in FIGS. 3 to 5, the flow-rate main passage outlet portion 432 is open on the housing rear surface 42.

As shown in FIG. 5, the flow-rate sub-passage inlet portion 441 is defined on the upper side of the flow-rate main passage 43, and a part of the air flowing through the flow-rate main passage 43 is introduced into the flow-rate sub-passage 44 through the flow-rate sub-passage inlet portion 441. The flow-rate sub-passage 44 is a passage branched off from the middle of the flow-rate main passage 43, and has an introducing portion 443, a rear vertical portion 444, a folded-back portion 445, and a front vertical portion 446. The introducing portion 443 is fluidly connected to the flow-rate sub-passage inlet portion 441 and extends upward from the flow-rate sub-passage inlet portion 441 toward the housing rear surface 42. As a result, a part of the air flowing through the flow-rate main passage 43 is easily introduced into the flow-rate sub-passage 44. The rear vertical portion 444 is fluidly connected to the end portion of the introducing portion 443 opposite to the flow-rate sub-passage inlet portion 441, and extends upward from the end portion of the introducing portion 443. The folded-back portion 445 is connected to the end portion of the rear vertical portion 444 opposite to the introducing portion 443, and extends from the end portion of the rear vertical portion 444 toward the housing base surface 41. The front vertical portion 446 is fluidly connected to the end portion of the folded-back portion 445 opposite to the rear vertical portion 444, and extends downward from the end portion of the folded-back portion 445. In the cross-sectional view of FIG. 5, in order to clarify each passage, the outlines of the flow-rate sub-passage inlet portion 441, the second physical quantity passage outlet portion 502, which will be described later, and the board 76 are omitted.

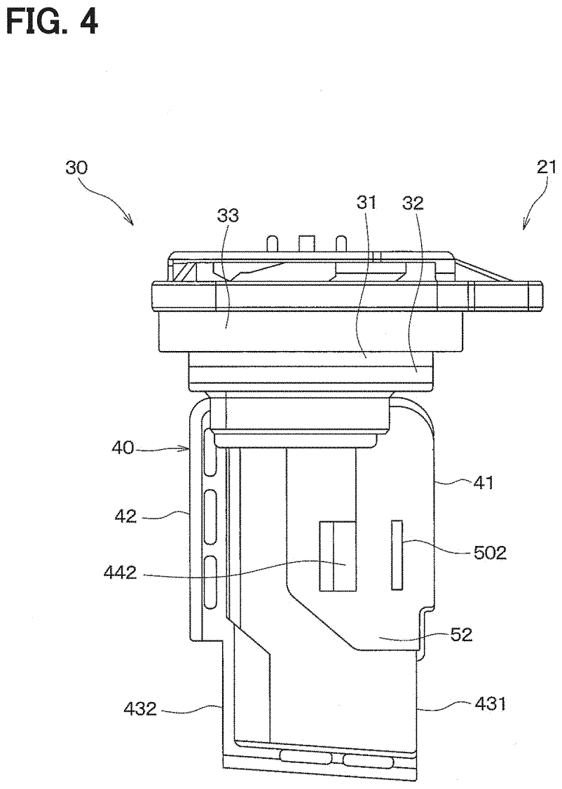

As shown in FIGS. 3 and 4, the flow-rate sub-passage outlet portions 442 are open respectively on the first housing side surface 51 and the second housing side surface 52, and in communication with the front vertical portion 446 and the outside of the housing 30.

As shown in FIG. 2, the housing base surface 41 defines one physical quantity passage inlet portion 500 at a position upward of the flow-rate main passage inlet portion 431. Further, the physical quantity passage inlet portion 500 introduces a part of the air flowing through the intake passage 111 into the physical quantity passage 50.

As shown in FIGS. 5 and 6, the physical quantity passage 50 is in communication with the physical quantity passage inlet portion 500, the first physical quantity passage outlet portion 501, and the second physical quantity passage outlet portion 502.

As shown in FIGS. 3 and 6, the number of the first physical quantity passage outlet portion 501 defined on the first housing side surface 51 is one.

As shown in FIGS. 4 and 6, the number of the second physical quantity passage outlet portion 502 defined on the second housing side surface 52 is one.

Further, as shown in FIGS. 2, 5 to 7, the physical quantity passage inlet portion 500 includes a first housing inner surface 61, a second hosing inner surface 62, a third housing inner surface 63, and a fourth housing inner surface 64. As shown in FIG. 6, the first housing inner surface 61 corresponds to a first inner surface, forms a side of the physical quantity passage inlet portion 500 close to the first housing side surface 51, and is connected to the housing base surface 41. The second housing inner surface 62 corresponds to a second inner surface, forms a side of the physical quantity passage inlet portion 500 close to the second housing side surface 52, and is connected to the housing base surface 41.

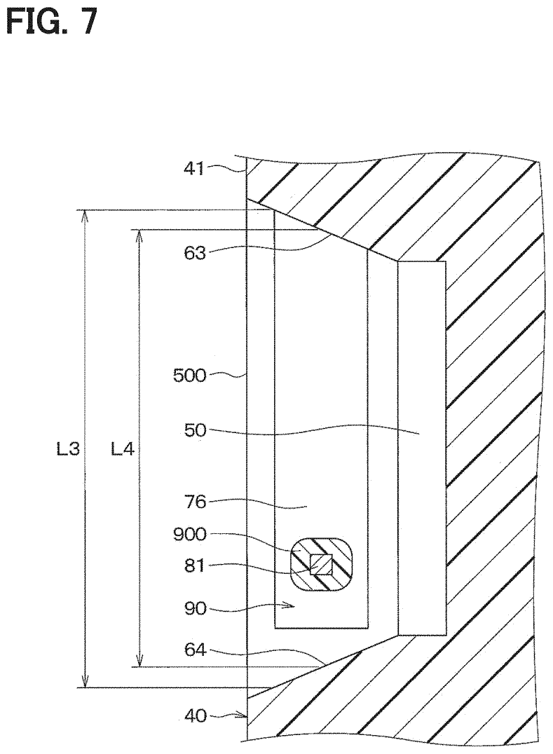

Further, as shown in FIG. 7, the third housing inner surface 63 corresponds to a third inner surface and is located on an upper side of the first housing inner surface 61 and the second housing inner surface 62. The third housing inner surface 63 is connected to the housing base surface 41, the first housing inner surface 61, and the second housing inner surface 62. The fourth housing inner surface 64 corresponds to a fourth inner surface and is located on a lower side of the first housing inner surface 61 and the second housing inner surface 62. Further, the fourth housing inner surface 64 is connected to the housing base surface 41, an end of the first housing inner surface 61 opposite to the third housing inner surface 63, and an end of the second housing inner surface 62 opposite to the third housing inner surface 63.

As shown in FIG. 5, the flow rate detector 75 is arranged in the folded-back portion 445 of the flow-rate sub-passage 44, and outputs signals corresponding to the flow rate of the air flowing through the flow-rate sub-passage 44. Specifically, the flow rate detector 75 includes a semiconductor including a heat generating element, a temperature sensitive element, and the like (not shown). This semiconductor contacts with the air flowing through the flow-rate sub-passage 44, thereby heat transfer is performed between the semiconductor and the air flowing through the flow-rate sub-passage 44. This heat transfer changes the temperature of the semiconductor. This temperature change correlates with the flow rate of the air flowing through the flow-rate sub-passage 44. Therefore, the flow rate detector 75 outputs signals corresponding to this temperature change, so that signals corresponding to the flow rate of the air flowing through the flow-rate sub-passage 44 are output. Further, the flow rate detector 75 is electrically connected to the other end of the terminal 35. As a result, the output signals of the flow rate detector 75 are transmitted to the electronic controller 18 via the terminal 35.

The board 76 is, for example, a printed circuit board made of glass, epoxy resin, or the like, and is electrically connected to the other end of the terminal 35. Further, as shown in FIGS. 2 and 6, the board 76 is arranged in the physical quantity passage inlet portion 500. Further, the board 76 faces the first housing inner surface 61 and the second housing inner surface 62. Further, here, the end surface of the board 76 facing the first housing inner surface 61 is referred to as a first board surface 761. Further, the end surface of the board 76 facing the second housing inner surface 62 is referred to as a second board surface 762. Then, as shown in FIGS. 6 and 7, the first board surface 761, the first housing inner surface 61, the third housing inner surface 63, and the fourth housing inner surface 64 define a board passage 90 therebetween.

The physical quantity detector 81 is mounted on the first board surface 761 of the board 76. Further, the physical quantity detector 81 outputs signals according to the physical quantity of the air flowing through the board passage 90. Here, the physical quantity of the air flowing through the board passage 90 is the temperature of the air flowing through the board passage 90. The physical quantity detector 81 has, for example, a thermistor (not shown) and outputs signals according to the temperature of the air flowing through the board passage 90, Further, since the physical quantity detector 81 is mounted on the board 76, the output signals of the physical quantity detector 81 are transmitted to the electronic controller 18 via the board 76 and the terminal 35.

Further, here, any one of the board 76, the first housing inner surface 61, the third housing inner surface 63, and the fourth housing inner surface 64 is formed to reduce an area of the board passage 90 in a direction from the housing base surface 41 toward the housing rear surface 42. Here, the area of the board passage 90 is a cross-sectional area of the board passage 90.

Specifically, as shown in FIG. 6, the board 76 has a board protrusion 900. The board protrusion 900 is arranged on the first board surface 761 of the board 76, and protrudes from the first board surface 761 toward the first housing inner surface 61 over the physical quantity detector 81. Further, the board protrusion 900 covers a part of the first board surface 761 and the physical quantity detector 81. Further, the outer contour of the board protrusion 900 is curved in a cross-section of the board protrusion 900 perpendicular to the longitudinal direction of the board 76. For example, the outer contour of the board protrusion 900 is formed in a streamlined shape. The streamlined shape is a shape along the streamline of the air flowing through the board passage 90. Further, the board protrusion 900 is formed, for example, by potting a resin.

Further, the first housing inner surface 61 has a housing protrusion 901. The housing protrusion 901 protrudes from the first housing inner surface 61 toward the physical quantity detector 81. Further, in the cross-section perpendicular to the longitudinal direction of the board 76, the outer contour of the housing protrusion 901 has an arc shape and is curved in a convex manner. The housing protrusion 901 is formed, for example, at the same time as a time when resin molding the first housing inner surface 61 of the bypass portion 40.

Here, an end portion of the first board surface 761 near the housing base surface 41 is referred to as a board end portion 763. In the cross-section perpendicular to the longitudinal direction of the board 76, a first distance L1 is defined as the shortest distance between the first housing inner surface 61 and the board end portion 763 in the thickness direction of the board 76. In the cross-section perpendicular to the longitudinal direction of the board 76, a second distance L2 is defined as the shortest distance between the board protrusion 900 and the housing protrusion 901 in the thickness direction of the board 76. The second distance L2 is less than the first distance L1 due to the board protrusion 900 and the housing protrusion 901, and the board passage 90 is reduced. As a result, the board 76 and the first housing inner surface 61 reduce a part of the board passage 90 in the direction from the housing base surface 41 toward the housing rear surface 42. Therefore, a cross-sectional area of a portion of the board passage 90 defined by the physical quantity detector 81, the board 76, the first housing inner surface 61, the third housing inner surface 63, and the fourth housing inner surface 64 is less than a cross-sectional area of a portion of the board passage near the housing base surface 41.

Further, here, as shown in FIGS. 5 and 7, the third housing inner surface 63 and the fourth housing inner surface 64 are tilted so that the cross-sectional area of the board passage 90 tapers in a direction from the housing base surface 41 toward the housing rear surface 42. Further, the third housing inner surface 63 and the fourth housing inner surface 64 are symmetrical relative to an axis extending from the housing base surface 41 toward the housing rear surface 42 to taper the cross-sectional area of the board passage 90,

Here, as shown in FIG. 7, in a cross-section perpendicular to the thickness direction of the board 76, a third distance L3 is defined as the distance between the third housing inner surface 63 and the fourth housing inner surface 64 at a position of the board passage 90 near the housing base surface 41. There is a passage in the board passage 90 that is defined by the physical quantity detector 81, the first board surface 761, the first housing inner surface 61, the third housing inner surface 63, and the fourth housing inner surface 64. In the cross-section perpendicular to the thickness direction of the board 76, a fourth distance L4 is defined as the distance between the third housing inner surface 63 and the fourth housing inner surface 64 at a position in the above-described passage. The fourth distance L4 is less than the third distance L3. As a result, the third housing inner surface 63 and the fourth housing inner surface 64 reduce a cross-sectional area of the board passage 90 in the direction from the housing base surface 41 toward the housing rear surface 42. Therefore, a cross-sectional area of a portion of the board passage 90 defined by the physical quantity detector 81, the board 76, the first housing inner surface 61, the third housing inner surface 63, and the fourth housing inner surface 64 is less than a cross-sectional area of a portion of the board passage near the housing base surface 41.

The airflow meter 21 is configured as described above. Next, the measurement of the flow rate and the temperature by the airflow meter 21 will be described.

A part of the air flowing through the intake passage 111 flows into the flow-rate main passage inlet portion 431. The air flowing into the flow-rate main passage inlet portion 431 flows through the flow-rate main passage 43 toward the flow-rate main passage outlet portion 432. A part of the air flowing through the flow-rate main passage 43 is discharged out of the housing 30 through the flow-rate main passage outlet portion 432.

Further, a part of the air flowing through the flow-rate main passage 43 flows into the flow-rate sub-passage inlet portion 441. The air flowing from the flow-rate sub-passage inlet portion 441 flows through the introducing portion 443 and the rear vertical portion 444 of the flow-rate sub-passage 44 into the folded-back portion 445. A part of the air flowing through the folded-back portion 445 contacts the flow rate detector 75. The flow rate detector 75 outputs signals corresponding to the flow rate of the air flowing through the flow-rate sub-passage 44 in response to contacting the air. The output signals of the flow rate detector 75 are transmitted to the electronic controller 18 via the terminal 35. Further, a part of the air flowing through the folded-back portion 445 is discharged out of the housing 30 through the front vertical portion 446 and the flow-rate sub-passage outlet portions 442 of the flow-rate sub-passage 44.

Further, a part of the air flowing through the intake passage 111 flows into the physical quantity passage inlet portion 500. A part of the air flowing into the physical quantity passage inlet portion 500 flows between the first housing inner surface 61 and the first board surface 761. The air flowing between the first housing inner surface 61 and the first board surface 761 further flows between the board protrusion 900 and the housing protrusion 901. A part of the air flowing between the board protrusion 900 and the housing protrusion 901 contacts the board protrusion 900. The board protrusion 900 transfers the heat of the air flowing between the board protrusion 900 and the housing protrusion 901 to the physical quantity detector 81. The physical quantity detector 81 receives the heat from a physical quantity detector cover 85 and outputs signals according to the temperature of the air flowing through the board passage 90. The output signals of the physical quantity detector 81 are transmitted to the electronic controller 18 via the board 76 and the terminal 35. Further, the air flowing between the board protrusion 900 and the housing protrusion 901 flows through the passage between the first housing inner surface 61 and the first board surface 761 into the physical quantity passage 50. The air flowing through the physical quantity passage 50 is discharged out of the housing 30 via the first physical quantity passage outlet portion 501 and the second physical quantity passage outlet portion 502.

As described above, the airflow meter 21 measures the airflow rate and the air temperature. In the airflow meter 21, the responsiveness to the air temperature is improved. In the following, this improvement in the responsiveness will be described.

In the airflow meter 21, the second distance L2 is less than the first distance L1, and a part of the board passage 90 is narrowed, As a result, a cross-sectional area of the board passage 90 is reduced. Therefore, the flow velocity of the air flowing between the board protrusion 900 and the housing protrusion 901 can be increased to higher than that of the air flowing through a passage between the first housing inner surface 61 near the housing base surface 41 and the first board surface 761 near the housing base surface 41. Since the flow velocity of the air that contacts the board protrusion 900 can be increased, a temperature boundary layer formed in the vicinity of the object, which is a region where the temperature changes, is thinned between the board protrusion 900 and the housing protrusion 901. When this temperature boundary layer becomes thin, the thermal resistance of a portion between the board protrusion 900 and the housing protrusion 901 decreases, and the local heat transfer coefficient of a portion between the board protrusion 900 and the housing protrusion 901 increases. Therefore, heat transfer between the physical quantity detector 81 and the air flowing between the board protrusion 900 and the housing protrusion 901 becomes easy. Therefore, when the temperature of the air flowing through the board passage 90 changes, the temperature of the physical quantity detector 81 is easily changed, so that the responsiveness of the physical quantity detector 81 is improved.

Further, the heat transfer from the housing 30 may decrease the accuracy of the measurement of the air temperature by the physical quantity detector 81. However, in the airflow meter 21, heat transfer between the physical quantity detector 81 and the air flowing between the board protrusion 900 and the housing protrusion 901 is easily performed, so that the physical quantity detector 81 can be easily cooled by the air flowing between the board protrusion 900 and the housing protrusion 901. Therefore, since the physical quantity detector 81 is less likely to be affected by the heat transfer from the housing 30, the airflow meter 21 can also improve the accuracy of temperature measurement of the air.

Further, the airflow meter 21 also has advantages as described in [1] to [3] below.

[1] Each of the outer contour of the board protrusion 900 and the outer contour of the housing protrusion 901 has a curved shape in the cross-section perpendicular to the longitudinal direction of the board 76. Since the outer contour of the board protrusion 900 and the outer contour of the housing protrusion 901 are curved, the air flowing through the board passage 90 flows along the outer contour of the board protrusion 900 and the outer contour of the housing protrusion 901. As a result, the pressure loss of the air flowing through the board passage 90 is reduced, thereby inhibiting the flow rate of the air flowing through the board passage 90 from being reduced. Therefore, since the flow rate of the air flowing through the board passage 90 becomes relatively large, the physical quantity detector 81 is easily cooled. Therefore, the physical quantity detector 81 is less likely to be affected by the heat transfer from the housing 30, and the accuracy of the temperature measurement of the air by the physical quantity detector 81 can be improved.

[2] In the intake passage 111, a corrosive substance such as salt water flows together with air. In the airflow meter 21 that introduces the air flowing through the intake passage 111, the housing protrusion 901 covers the physical quantity detector 81. As a result, corrosion of the physical quantity detector 81 is suppressed.

[3] The third housing inner surface 63 and the fourth housing inner surface 64 are tilted relative to a direction from the housing base surface 41 toward the housing rear surface 42 so that the physical quantity passage inlet portion 500 tapers. Further, the fourth distance L4 is less than the third distance L3. As a result, the board passage 90 is reduced, so that the flow velocity of the air flowing through the board passage 90 becomes high. Therefore, the flow velocity of the air that contacts the board protrusion 900 becomes high. Therefore, as described above, heat transfer between the physical quantity detector 81 and the air flowing between the board protrusion 900 and the housing protrusion 901 easily occur.

Further, the air flowing through the board passage 90 flows along the tilted third housing inner surface 63 and the tilted fourth housing inner surface 64. As a result, the pressure loss of the air flowing through the board passage 90 is reduced, thereby inhibiting the flow rate of the air flowing through the board passage 90 from being reduced.

### Second Embodiment

The second embodiment differs from the first embodiment in the following points. In the second embodiment, the arrangement of the housing protrusion is different from that in the first embodiment. Further, in the second embodiment, the arrangement of the first housing inner surface and the second housing inner surface are different from those of the first embodiment.

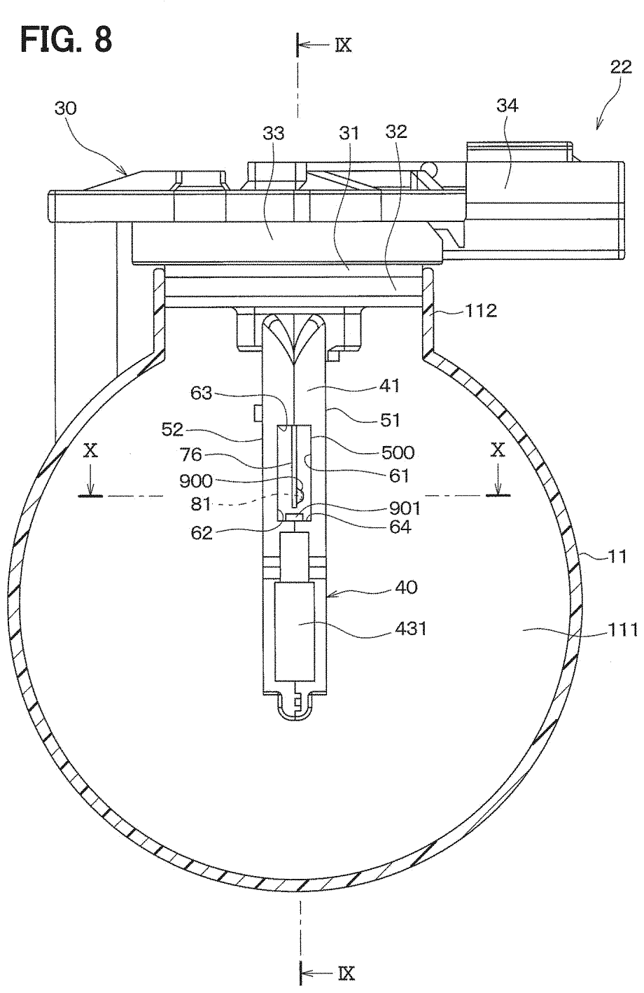

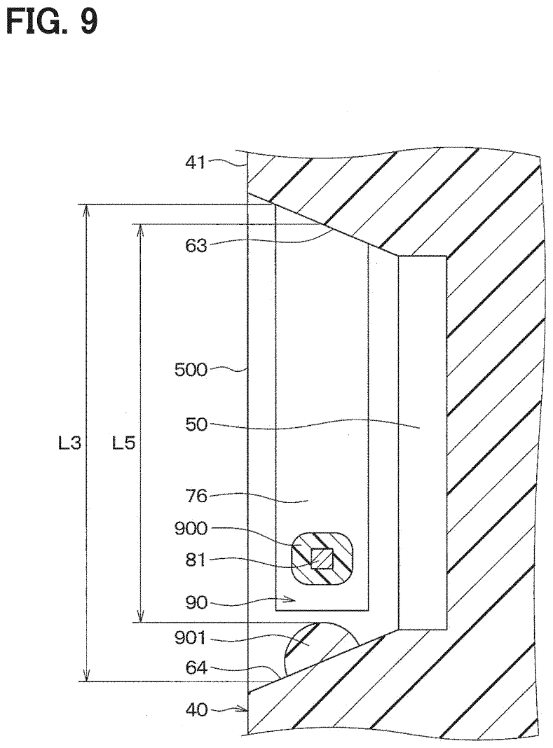

In an airflow meter 22 of the second embodiment, as shown in FIGS. 8 and 9, the fourth housing inner surface 64 has a housing protrusion 901. The housing protrusion 901 protrudes from the fourth housing inner surface 64 toward the physical quantity detector 81. Further, the housing protrusion 901 extends in the thickness direction of the board 76 so as to face the board protrusion 900 and the physical quantity detector 81. Further, in the cross-section perpendicular to the thickness direction of the board 76, the outer contour of the housing protrusion 901 is formed in an arc shape and is curved in a convex manner.

Here, similarly to the above-described embodiment, in the cross-section perpendicular to the thickness direction of the board 76, the third distance L3 is defined as the distance between the third housing inner surface 63 and the fourth housing inner surface 64 at a position of the board passage 90 near the housing base surface 41. Further, as shown in FIG. 9, in the cross-section perpendicular to the thickness direction of the board 76, a fifth distance L5 is defined as a distance between the third housing inner surface 63 and the housing protrusion 901 in the longitudinal direction of the board 76. The fifth distance L5 is less than the third distance L3 due to the board protrusion 900 and the housing protrusion 901, and a part of the board passage 90 is reduced. As a result, the board 76 and the fourth housing inner surface 64 reduce a part of the board passage 90 in the direction from the housing base surface 41 toward the housing rear surface 42. Therefore, a cross-sectional area of a portion of the board passage 90 defined by the physical quantity detector 81, the board 76, the first housing inner surface 61, the third housing inner surface 63, and the fourth housing inner surface 64 is less than a cross-sectional area of a portion of the board passage near the housing base surface 41.

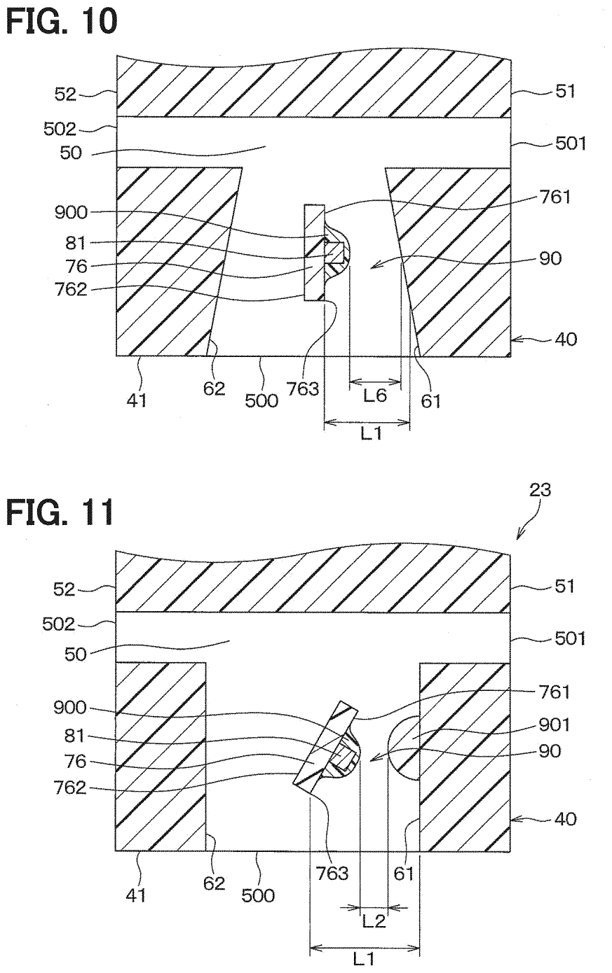

Further, in the airflow meter 22 of the second embodiment, as shown in FIG. 10, the first housing inner surface 61 and the second housing inner surface 62 are tilted to taper the board passage 90 in the direction from the housing base surface 41 toward the housing rear surface 42. Further, here, the first housing inner surface 61 and the second housing inner surface 62 are symmetrical relative to the axis extending in the direction from the housing base surface 41 toward the housing rear surface 42 to taper the cross-sectional area of the board passage 90.

Here, in the cross-section perpendicular to the longitudinal direction of the board 76, a sixth distance L6 is defined as the shortest distance between the first housing inner surface 61 and the board protrusion 900 in the thickness direction of the board 76. The sixth distance L6 is smaller than the first distance L1, and a part of the board passage 90 is narrowed. As a result, the board 76 and the first housing inner surface 61 reduce a part of the board passage 90 in the direction from the housing base surface 41 toward the housing rear surface 42. Therefore, a cross-sectional area of a portion of the board passage 90 defined by the physical quantity detector 81, the board 76, the first housing inner surface 61, the third housing inner surface 63, and the fourth housing inner surface 64 is less than a cross-sectional area of a portion of the board passage near the housing base surface 41.

In the second embodiment, similar advantages to those of the first embodiment can be achieved. Further, in the second embodiment, the first housing inner surface 61 is tilted so that the board passage 90 is reduced in a direction from the housing base surface 41 toward the housing rear surface 42. As a result, the flow velocity of the air flowing through the board passage 90 becomes high. Therefore, the flow velocity of the air that contacts the board protrusion 900 becomes high. Therefore, as described above, heat transfer between the physical quantity detector 81 and the air flowing between the board protrusion 900 and the housing protrusion 901 easily occur.

### Third Embodiment

The third embodiment is the same as the first embodiment except for the arrangement of the board.

In the airflow meter 23 of the third embodiment, as shown in FIG. 11, the board 76 is tilted with respect to the first housing inner surface 61. As a result, the board protrusion 900 and the physical quantity detector 81 face in a direction toward the housing base surface 41.

Here, since the board 76 is tilted, in the cross-section perpendicular to the longitudinal direction of the board 76, the first distance L1 corresponds to the shortest distance between the first housing inner surface 61 and the board end portion 763 in a direction from the first housing inner surface 61 toward the second housing inner surface 62. Further, in the cross-section perpendicular to the longitudinal direction of the board 76, the second distance L2 corresponds to the shortest distance between the board protrusion 900 and the housing protrusion 901 in the direction from the first housing inner surface 61 to the second housing inner surface 62.

Since the board 76 is tilted with respect to the first housing inner surface 61 as described above, the cross-sectional area of the board passage 90 is reduced in a direction from the housing base surface 41 toward the housing rear surface 42.

In this third embodiment as described above, similar advantages to those of the first embodiment can be obtained. Further, in the third embodiment, the board 76 is tilted to reduce the cross-sectional area of the board passage 90. Therefore, it is not necessary to process the housing 30, and the housing 30 can be easily manufactured.

Further, since the board 76 is tilted so that the board protrusion 900 and the physical quantity detector 81 face in a direction toward the outside of the housing base surface 41, the air flowing through the board passage 90 is more likely to contact the board protrusion 900 and the physical quantity detector 81. Thereby, it becomes easier to perform heat transfer between the physical quantity detector 81 and the air flowing through the board passage 90 and the board protrusion 900.

### Other Embodiments

The present disclosure is not limited to the above-described embodiments, and the above embodiments can be appropriately modified. Further, in each of the above-mentioned embodiments, it goes without saying that components of the embodiment are not necessarily essential except for a case in which the components are particularly dearly specified as essential components, a case in which the components are clearly considered in principle as essential components, and the like.

(1) In the above embodiments, the physical quantity detector 81 outputs signals according to the temperature of the air flowing through the board passage 90. However, the physical quantity detector 81 is not limited to outputting signals according to the temperature of the air flowing through the board passage 90. The physical quantity detector 81 may output signals according to the relative humidity of the air flowing through the board passage 90. Further, the physical quantity detector 81 may output signals according to the pressure of the air flowing through the board passage 90. Similar to the responsiveness to the temperature, responsiveness to the relative humidity and pressure may decrease due to heat transfer between the air flowing through the board passage 90 and the physical quantity detector 81. In the above embodiments, since heat transfer between the air flowing through the board passage 90 and the physical quantity detector 81 is easily performed, the responsiveness to relative humidity and pressure can also be improved.

(2) In the above embodiments, the first housing inner surface 61, the second housing inner surface 62, the third housing inner surface 63, and the fourth housing inner surface 64 are each formed as a flat surface. On the other hand, each of the first housing inner surface 61, the second housing inner surface 62, the third housing inner surface 63, and the fourth housing inner surface 64 is not limited to a flat surface, and may be formed as a curved surface or a stepped surface.

(3) In the above embodiments, the first physical quantity passage outlet portion 501 is open on the first housing side surface 51, and the second physical quantity passage outlet portion 502 is open on the second housing side surface 52. However, the first physical quantity passage outlet portion 501 may be open on the first housing side surface 51, and the second physical quantity passage outlet portion 502 may not be open on the second housing side surface 52. Further, the second physical quantity passage outlet portion 502 may be open on the second housing side surface 52, and the first physical quantity passage outlet portion 501 may not be open on the first housing side surface 51.

(4) In the above embodiments, the number of each of the first physical quantity passage outlet portion 501 and the second physical quantity passage outlet portion 502 is one, However, the number of each of the first physical quantity passage outlet portion 501 and the second physical quantity passage outlet portion 502 is not limited to one, and may be two or more. Further, in the above embodiments, the first physical quantity passage outlet portion 501 and the second physical quantity passage outlet portion 502 are each formed in a rectangular shape, However, the shape of each of the first physical quantity passage outlet portion 501 and the second physical quantity passage outlet portion 502 is not limited to a rectangular shape, and may be a polygonal shape, a circular shape, or an elliptical shape.

(5) In the above embodiments, the number of the physical quantity passage inlet portion 500 is one. However, the number of the physical quantity passage inlet portion 500 is not limited to one, and may be two or more. Further, in the above embodiments, the physical quantity passage inlet portion 500 is formed in a rectangular shape. On the other hand, the shape of the physical quantity passage inlet portion 500 is not limited to a rectangular shape, and may be a polygonal shape, a circular shape, or an elliptical shape.

(6) The airflow meter 21 of the first embodiment and the airflow meter 22 of the second embodiment may be combined. Further, the third housing inner surface 63 may have a housing protrusion.

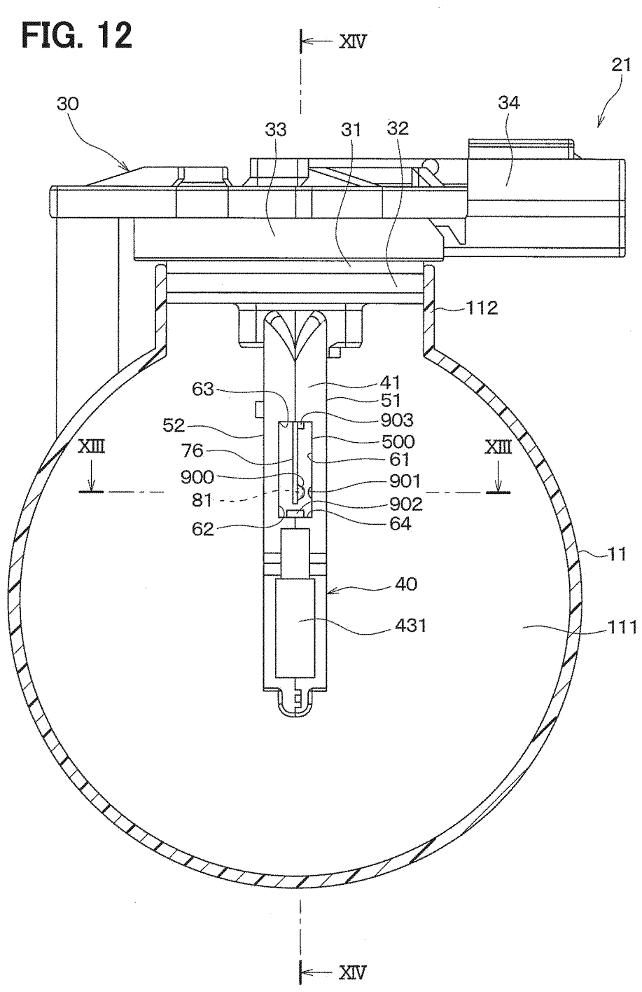

Specifically, as shown in FIGS. 12 to 14, in the airflow meter 21, the first housing inner surface 61 has the housing protrusion 901, the third housing inner surface 63 has the housing protrusion 903, and the fourth housing inner surface 64 has a housing protrusion 902, In the following, in order to clarify the housing protrusions 901, 902, and 903, the housing protrusion 901 of the first housing inner surface 61 is described as the first housing protrusion 901. The housing protrusion 902 of the fourth housing inner surface 64 is described as the second housing protrusion 902, The housing protrusion 903 of the third housing inner surface 63 is described as the third housing protrusion 903.

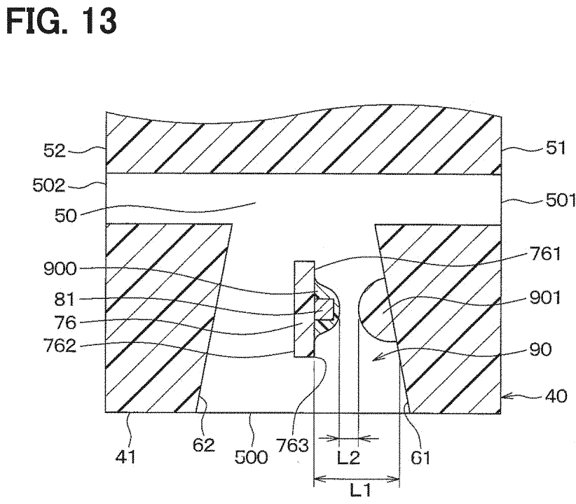

As shown in FIG. 13, the first housing protrusion 901 protrudes from the first housing inner surface 61 toward the physical quantity detector 81, as in the first embodiment. Further, here, the first housing inner surface 61 is tilted to reduce the board passage 90 in the direction from the housing base surface 41 toward the housing rear surface 42.

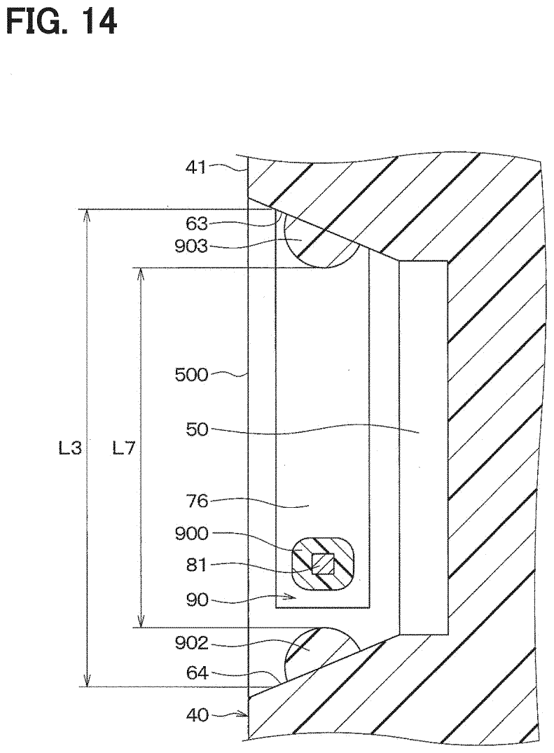

Further, as shown in FIG. 14, the second housing protrusion 902 protrudes from the fourth housing inner surface 64 toward the physical quantity detector 81, as in the second embodiment.

Further, the third housing protrusion 903 protrudes from the third housing inner surface 63 toward the physical quantity detector 81 to face the physical quantity detector 81 and the board protrusion 900.

Here, in the cross-section perpendicular to the thickness direction of the board 76, a seventh distance L7 is defined as the shortest distance between the second housing protrusion 902 and the third housing protrusion 903 in the longitudinal direction of the board 76. The seventh distance L7 is less than the third distance L3, and a part of the board passage 90 is narrowed. As a result, the board 76 and the third housing inner surface 63 reduce the cross-sectional area of the board passage 90 in the direction from the housing base surface 41 toward the housing rear surface 42. Therefore, a cross-sectional area of a portion of the board passage 90 defined by the physical quantity detector 81, the board 76, the first housing inner surface 61, the third housing inner surface 63, and the fourth housing inner surface 64 is less than a cross-sectional area of a portion of the board passage near the housing base surface 41. Even in this embodiment, the same advantages as those of the above-described embodiments can be obtained.

Further, multiple of the first housing protrusions 901, the second housing protrusions 902, and the third housing protrusions 903 may be formed. The number of each of the first housing protrusion 901, the second housing protrusion 902, and the third housing protrusion 903 is not limited to one, and may be two or more,

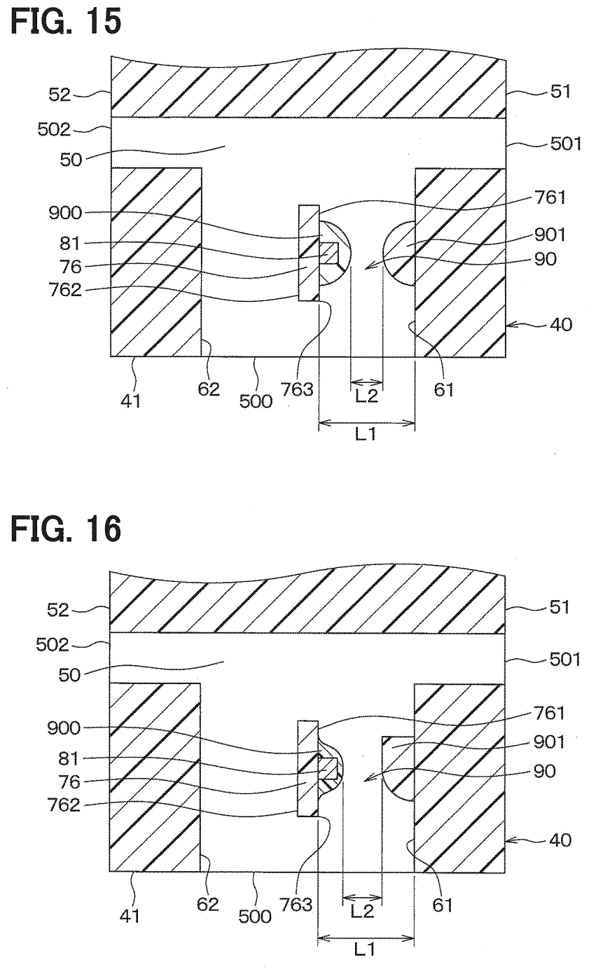

(7) In the above embodiments, the outer contour of the board protrusion 900 is formed in a streamlined shape in a cross-section perpendicular to the longitudinal direction of the board 76. However, the shape of the outer contour of the board protrusion 900 in the cross-section perpendicular to the longitudinal direction of the board 76 is not limited to a streamlined shape. For example, as shown in FIG. 15, the shape of the outer contour of the board protrusion 900 in the cross-section perpendicular to the longitudinal direction of the board 76 may be a semicircular shape.

(8) In the above embodiments, the outer contour of the housing protrusion 901 has an arc shape. However, the outer contour of the housing protrusion 901 may not have an arc shape. For example, as shown in FIG. 16, a part of the outer contour of the housing protrusion 901 facing in a direction toward the housing base surface 41 may be curved to protrude in an arc shape. Further, a part of the outer contour of the housing protrusion 901 facing in a direction toward the housing rear surface 42 may be straight.

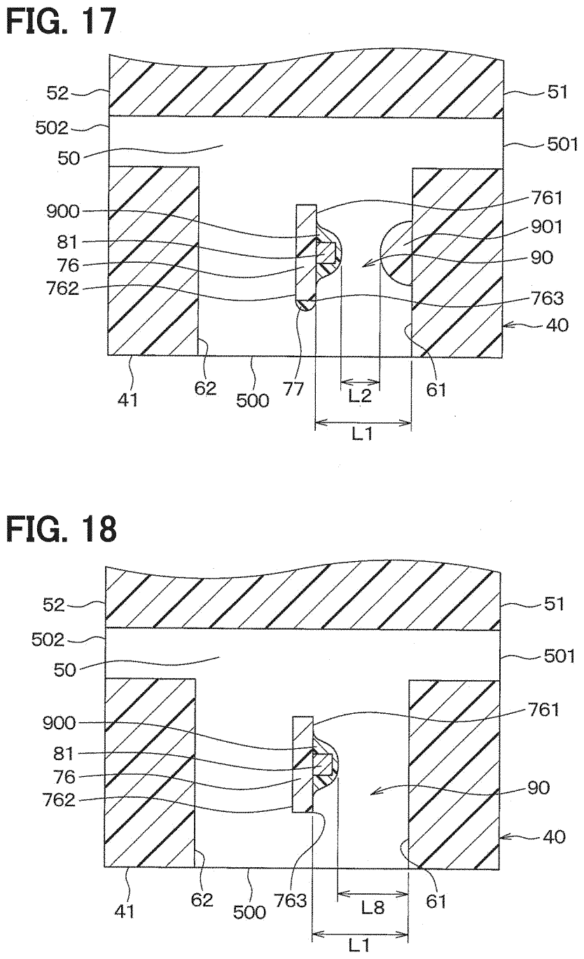

(9) As shown in FIG. 17, the airflow meter 21 may include a board protecting portion 77. The board protecting portion 77 is formed, for example, by coating a resin on a surface of the board 76 extending in the thickness direction of the board 76. The board protecting portion 77 faces an upstream side of the physical quantity passage inlet portion 500 and protects the board 76 by covering the surface of the board 76 extending in the thickness direction of the board 76. Further, the outer contour of the board protecting portion 77 is curved in the cross-section perpendicular to the longitudinal direction of the board 76. Further, in the cross-section perpendicular to the longitudinal direction of the board 76, the center of curvature of the outer contour of the board protecting portion 77 is located inside either the board 76 or the board protecting portion 77, and the outer contour of the board protecting portion 77 is curved in a convex manner. The board protecting portion suppresses corrosion of the board 76.

Further, since the outer contour of the board protecting portion 77 is curved in a convex manner, the air flowing through the board passage 90 flows along the outer contour of the board protecting portion 77. As a result, the pressure loss of the air flowing through the board passage 90 is reduced, thereby inhibiting the flow rate of the air flowing through the board passage 90 from being reduced. Therefore, since the flow rate of the air flowing through the board passage 90 becomes relatively large, the physical quantity detector 81 is easily cooled. Therefore, the physical quantity detector 81 is less likely to be affected by the heat transfer from the housing 30, and the accuracy of the temperature measurement of the air by the physical quantity detector 81 can be improved.

(10) In the first embodiment, both the board protrusion 900 and the housing protrusion 901 are formed. However, the present disclosure is not limited to forming both the board protrusion 900 and the housing protrusion 901. Either one of the board protrusion 900 and the housing protrusion 901 may be formed.

Specifically, as shown in FIG. 18, the board 76 has the board protrusion 900, and the first housing inner surface 61 does not have the housing protrusion 901. In this case, in the cross-section perpendicular to the longitudinal direction of the board 76, an eighth distance L8 is defined as the shortest distance between the first housing inner surface 61 and the board protrusion 900 in the thickness direction of the board 76. Because of the board protrusion 900, the eighth distance L8 is less than the first distance L1, and a part of the board passage 90 is narrowed. As a result, the board 76 reduces the cross-sectional area of the board passage 90 in the direction from the housing base surface 41 toward the housing rear surface 42. Therefore, a cross-sectional area of a portion of the board passage defined 90 by the physical quantity detector 81, the board 76, the first housing inner surface 61, the third housing inner surface 63, and the fourth housing inner surface 64 is less than a cross-sectional area of a portion of the board passage near the housing base surface 41.

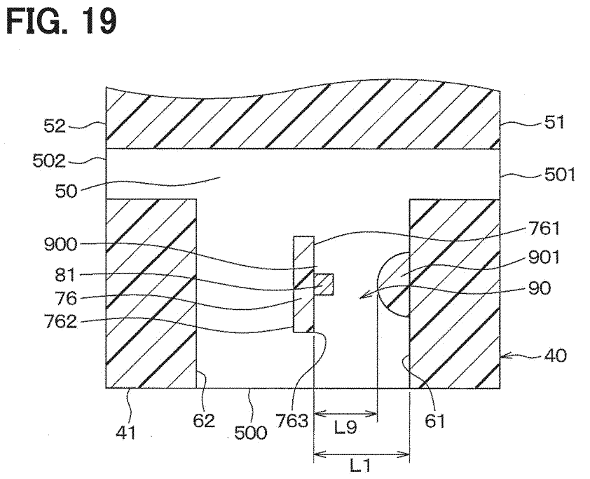

Further, as shown in FIG. 19, the board 76 does not have the board protrusion 900, and the first housing inner surface 61 has the housing protrusion 901. In this case, in the cross-section perpendicular to the longitudinal direction of the board 76, a ninth distance L9 is defined as the shortest distance between the first board surface 761 and the housing protrusion 901 in the thickness direction of the board 76. Because of the housing protrusion 901, the ninth distance L9 is less than the first distance L1, and a part of the board passage 90 is narrowed. As a result, the first housing inner surface 61 reduces the cross-sectional area of the board passage 90 in the direction from the housing base surface 41 to the housing rear surface 42. Therefore, a cross-sectional area of a portion of the board passage 90 defined by the physical quantity detector 81, the board 76, the first housing inner surface 61, the third housing inner surface 63, and the fourth housing inner surface 64 is less than a cross-sectional area of a portion of the board passage near the housing base surface 41.

(11) In the above embodiments, the pipe extending portion 112 is formed into a cylindrical shape. However, the shape of the pipe extending portion 112 is not limited to a cylindrical shape, and may be formed into a tubular shape such as a polygonal tubular shape.

(12) In the above embodiments, the holding portion 31 is formed into a cylindrical shape. However, the shape of the holding portion 31 is not limited to a cylindrical shape, and may be a tubular shape such as a polygonal tubular shape.

(13) In the above embodiment, the connector cover 34 radially extends from the inside to the outside of the holding portion 31. However, the connector cover 34 is not limited to radially extending from the inside to the outside of the holding portion 31, and may extend in the axial direction of the holding portion 31.

(14) In the above embodiments, the flow-rate sub-passage 44 is branched off from the middle of the flow-rate main passage 43. However, the flow-rate sub-passage 44 is not limited to being branched off from the middle of the flow-rate main passage 43. For example, the flow-rate main passage 43 and the flow-rate sub-passage 44 may be formed as a single passage by forming the flow-rate main passage 43 not to be in communication with the flow-rate main passage outlet portion 432 and forming the flow-rate sub-passage 44 to be in communication with the flow-rate sub passage outlet portion 432.

(15) In the above embodiments, the housing base surface 41 also includes a virtual plane on which the housing base surface 41 virtually extends.

(16) In the above embodiments, the first physical quantity passage outlet portion 501 is open on the first housing side surface 51. However, the first physical quantity passage outlet portion 501 is not limited to being open on the first housing side surface 51, and may be open on the housing rear surface 42. Further, the second physical quantity passage outlet portion 502 is defined on the second housing side surface 52. However, the second physical quantity passage outlet portion 502 is not limited to being open on the second housing side surface 52, and may be open on the housing rear surface 42.

What is claimed is:

1. An airflow meter comprising:
a housing including:
a base surface on which a flow-rate passage inlet portion and a physical quantity passage inlet portion are open;
a rear surface on which a flow-rate passage outlet portion is open, the rear surface being located opposite to the base surface;
a first side surface connecting between an end of the base surface and an end of the rear surface;
a second side surface connecting between an opposite end of the base surface and an opposite end of the rear surface; and
a flow-rate passage fluidly connecting between the flow-rate passage inlet portion and the flow-rate passage outlet portion;
a flow rate detector disposed in the flow-rate passage and configured to output signals according to a flow rate of an air flowing through the flow-rate passage;
a board disposed in the physical quantity passage inlet portion and having a board surface facing in a direction toward the first side surface; and
a physical quantity detector mounted on the board surface of the board, wherein
the physical quantity passage inlet portion includes a first inner surface, a second inner surface, a third inner surface, and a fourth inner surface,
the first inner surface forms a side of the physical quantity passage inlet portion close to the first side surface, the second inner surface forms a side of the physical quantity passage inlet portion close to the second side surface, the third inner surface connects between the base surface, an end of the first inner surface, and an end of the second inner surface, and the fourth inner surface connects between the base surface, an opposite end of the first inner surface, and an opposite end of the second inner surface,
the physical quantity detector is disposed in a board passage defined by the board surface, the first inner surface, the third inner surface, and the fourth inner surface and configured to output signals according to a physical quantity of an air flowing through the board passage, and
the board, the first inner surface, the third inner surface, and the fourth inner surface are arranged such that a cross-sectional area of the board passage is reduced in a direction from the base surface toward the rear surface, whereby a cross-sectional area of a portion of the board passage that is defined between the physical quantity detector, the board, the first inner surface, the third inner surface, and the fourth inner surface is less than a cross-sectional area of a portion of the board passage near the base surface.

2. The airflow meter according to claim 1, wherein
the board includes a board protrusion protruding toward the first inner surface and covering the physical quantity detector to reduce the cross-sectional area of the board passage.

3. The airflow meter according to claim 1, wherein
the first inner surface includes a housing protrusion protruding from the first inner surface toward the physical quantity detector to reduce the cross-sectional area of the board passage.

4. The airflow meter according to claim 1, wherein
at least one of the third inner surface or the fourth inner surface includes a housing protrusion protruding from the at least one of the third inner surface or the fourth inner surface toward the physical quantity detector to reduce the cross-sectional area of the board passage.

5. The airflow meter according to claim 3, wherein
the housing protrusion has a curved surface.

6. The airflow meter according to claim 1, wherein
the board is tilted relative to the first inner surface such that the physical quantity detector diagonally faces the base surface to reduce the cross-sectional area of the board passage.

7. The airflow meter according to claim 1, wherein
at least one of the first inner surface, the third inner surface, or the fourth inner surface is tilted relative to a direction from the base surface to the rear surface to taper the cross-sectional area of the board passage.
